(19) United States
(12) Patent Application Publication
(10) Pub. No.: US 2007/0168419 A1
(43) Pub. Date: Jul. 19, 2007

(54) System, method, and article of manufacture for a network media channel

(76) Inventor: Eduardo A. Sciammarella, New York, NY (US)

Correspondence Address: LAW OFFICES OF MICHAEL M. AHMADSHAHI, 575 ANTON BLVD,. STE 300, COSTA MESA, CA, 92626, US

(21) Appl. No.: 11/312,291

(22) Filed: Dec. 19, 2005

(51) Int. Cl. G06F 15/16

(52) U.S. Cl. 709/204; 709/231; 709/232

(57) ABSTRACT

This invention discloses a network media channel that can be used by the subscribers of the channel to share media files based on ad-hoc specifications. Temporal, spatial, channel identity and mask components, or any combination thereof, are among the specifications that subscribers can use to create ad-hoc specifications. A transmitting subscriber creates a media file and a kernel containing the ad-hoc specifications, wherein the media file is stored according to the first kernel. Access to the media file is according to the first kernel. A receiving subscriber can in turn create a second kernel to introduce additional refinements to the ad-hoc specification and be notified according to the first and second kernel. The receiving subscriber may retrieve the media file upon reception of the notice.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to network media channels that allow subscribers to share media files with one another. More specifically, the present invention is related to a network media channel that allows subscribers to define ad-hoc specification for sharing their media files.

### BACKGROUND

The present invention relates to a network media channel that can be used by subscribers of the channel for sharing media files. More specifically, the present invention focuses on sharing media files according to impromptu specifications by the operation of a first and second kernels created by the subscribers. Temporal, spatial, channel identity, masks, and any combination thereof, are among the components that subscribers can include in their ad-hoc specifications to link with one another. Accordingly, the present invention facilitates links between subscribers with ad-hoc specification, and provides means to reduce network traffic.

Communication between people, via private and/or public networks, has become widespread and growing. Individuals use a myriad of devices, fixed or portable, to communicate with one another. These devices are equipped with text, image, audio, and video recording capabilities. Many subscribers to such networks use these devices for social interactions. These social interactions occur not only between subscribers who are acquainted with each other, but also between those who are unknown to one another.

Subscribers, known or unknown, share files with one another. These files include text, image, audio, and video formats. Many different forms of media file can be created in this manner, which use one or more combination of these formats. Ordinarily, subscribers do not know what type of file they will be exchanging. As the volume of data increases, subscribers can become inundated with sorting the information they receive from other subscribers.

Presence technology allows subscribers and network elements to know the status, availability, location, and type of device used by other subscribers. Recognizing the presence of a known receiving subscriber will aid a transmitting subscriber and/or server to make a more informed selection when creating their ad-hoc specifications. For instance, a transmitting subscriber may choose to share text only, as opposed to image, with a receiving subscriber if the former knows that the latter's type of device is one that can not handle large data files. In a variation of this example, a server, instead of the transmitting subscriber, may be programmed to automatically select the receiving subscriber's most suitable device. In another instance, a transmitting subscriber may choose not to share information at all if the target receiving subscriber is not available to receive the information, or if she is not within a favorable geographical location.

Moreover, as the number of subscribers grows, network traffic becomes more congested. Subscribers routinely upload and download files via such network media channels. In this manner, an enormous amount of data is shared between the subscribers, and the network media channel must be able to handle the traffic. A user defined filter can substantially reduce the number of unwanted file sharing.

Although various systems have been proposed which touch upon some aspects of the above problems, they do not provide solutions to the existing limitations in providing a network media channel. For example, in Schwesig et al., U.S. Pat. App. No. 20050010635 A1, hereby incorporated by reference in its entirety, the disclosure describes a network media channel that allows subscribers to create media files that include metadata, including timestamps, keywords, author information, authorization information, subject information, location information, and network media channel information. However, such metadata is utilized to assist in processing and organizing the media data. The present invention uses similar constraints (discussed below) but allows a transmitting subscriber to create his/her own ad-hoc kernel to be used for notifying other subscribers that match those constraints. Additionally, the present invention provides for a media channel where unknown subscribers may share media files, whereas the aforementioned disclosure relates to media channels where subscribers must necessarily subscribe to media channels of other known subscribers.

Network media channels facilitate a unique method of communication between individuals. Of particular interest is the manner in which such network media channels can be used in social interactions between known and unknown subscribers. With the advent of sophisticated but easy-to-use devices, such as PDAs, subscribers can share their life experiences with one another. The challenge is to provide a network media channel that is intuitive and user friendly, and one that enables its subscribers to actively participate in communicating and sharing information. One method of facilitating active participation is to allow the subscribers to create their own conditions, as to time, space, channel identity, mask, or any combination thereof, for such communication and information exchange. Therefore, there is a need for a network media channel that enables its subscribers to create their own ad-hoc specifications while reducing network media channel traffic.

### SUMMARY

The present invention discloses a system, method and article of manufacture for a network media channel. The system comprises one or more devices, networks, and servers. A transmitting subscriber may use one of the devices to create one or more media files and upload them along with a first kernel to a server via a network. The server stores the media files in a repository and allows access to said media files according to the first kernel. The first kernel is used to create an ad-hoc specification regarding the media file. One or more receiving subscribers may further create a second kernel to receive the one or more media files according to the second kernel. Accordingly, the operation of the first and second kernels, specified by the transmitting and receiving subscribers, provides for an impromptu exchange of information while reducing the network traffic.

In one aspect, a network media channel is provided that allows subscribers to specify ad-hoc constraints regarding their media files. Preferably, the devices include mobile phones, personal computers, personal digital assistants, and/or laptop computers, capable of creating media files which comprise text, image, audio, and/or video components.

In another aspect, a network media channel is provided that allows subscribers to specify ad-hoc constraints regarding their media files. Preferably, the devices are clients according to server-client architecture and the network includes a presence-based network including those with appropriate protocols which allow the subscribers and network elements, such as the server, to know the status, availability, location, and type of device used by other subscribers. Preferably, all transmissions and/or receptions via the network of any type may occur via wired and/or wireless connection.

In another aspect, a network media channel is provided that allows subscribers to specify ad-hoc constraints regarding their media files. Preferably, a transmitting subscriber creates a first kernel comprising a temporal, spatial, channel identity, and/or mask components. Preferably, the temporal component includes a local time and/or a temporal period, the spatial component includes a geographic location and/or a spatial boundary, the channel identity includes a LifeChannel for user-generated content, a MediaLife for entertainment and information content, a NaviLife for scheduling and event content, and/or a LocalLife for location content, and the mask component includes a keyword and/or an identification list, the latter may include at least one of a name, gender, age, and physical attribute.

In another aspect, a network media channel is provided that allows subscribers to specify ad-hoc constraints regarding their media files. Preferably, the channel further allows one or more receiving subscribers, to create a second kernel for receiving one or more media files from the repository upon a notice from a server, such notice being transmitted according to the first and second kernel. Preferably, the server transmits the notice when an operation of the first kernel on the second kernel results in a match. Preferably, the second kernel comprises a temporal, spatial, channel identity, and/or mask components.

In another aspect, a network media channel is provided that allows subscribers to specify ad-hoc constraints regarding their media files. Preferably, the method further comprises modifying the first kernel, uploading the first kernel to the server, wherein the server replaces the first kernel with the modified kernel. Preferably, upon such modification, the server modifies a received media file according to the modified first kernel. Preferably, a modification of a received media file comprises deleting said received media file.

### BRIEF DESCRIPTION OF THE DRAWINGS

FIG. 1 is a diagram depicting one preferred embodiment of a system implementing the network media channel according to the present invention.

FIG. 2 shows a flow diagram of one preferred method of providing a network media channel.

FIG. 3 shows a flow diagram of one preferred method of creating a media file.

FIG. 4 shows a schematic diagram of a media file according to a preferred embodiment.

FIG. 5 is a diagram depicting preferred embodiments of a client.

FIG. 6 shows a flow diagram of one preferred method of creating a kernel.

FIG. 7 shows a schematic diagram of a kernel according to a preferred embodiment.

FIG. 8 shows a schematic diagram of a temporal component according to a preferred embodiment.

FIG. 9 shows a schematic diagram of a spatial component according to a preferred embodiment.

FIG. 10 shows a schematic diagram of a channel identity component according to a preferred embodiment.

FIG. 11 shows a schematic diagram of a mask component according to a preferred embodiment.

FIG. 12 shows a schematic diagram of an identification list according to a preferred embodiment.

FIG. 13 shows a schematic diagram of a repository according to a preferred embodiment.

FIG. 14 is a flow diagram of one preferred method of retrieving a media file.

FIG. 15 is a flow diagram of one preferred method of modifying a first kernel.

FIG. 16 is a flow diagram of one preferred method of modifying a second kernel.

### DETAILED DESCRIPTION OF THE PRESENTLY PREFERRED EMBODIMENTS

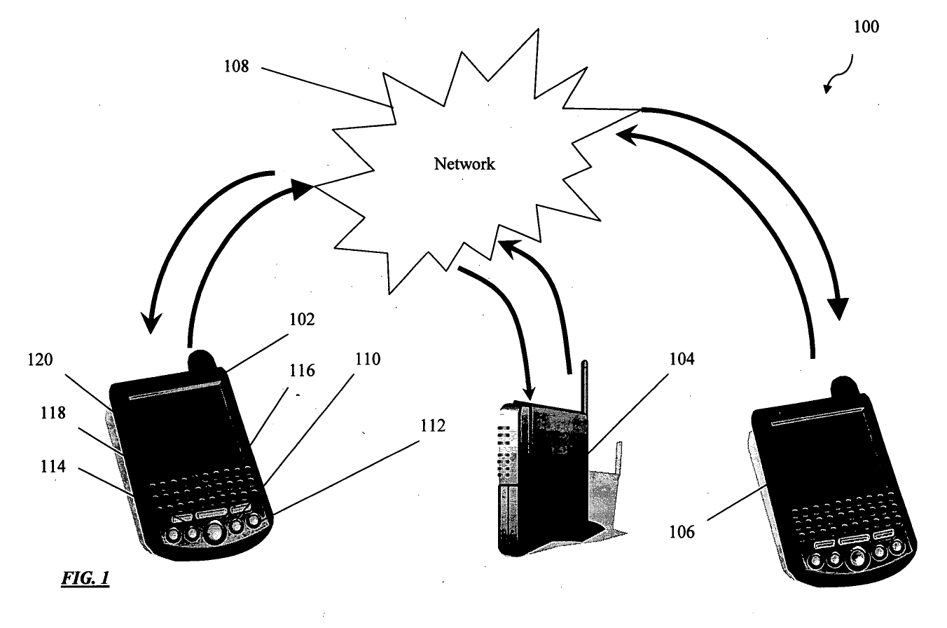

FIG. 1 depicts a diagram of one preferred embodiment of a system 100 implementing a network media channel according to the present invention. The system 100 comprises a first mobile device 102, a server 104, and a second mobile device 106 interconnected via a network 108, such as the Internet. The first mobile device 102 is capable of creating a media file containing text, image, audio, video, or any combination thereof, and transmitting it to the network 108. The first mobile device 102 is further capable of creating a first kernel (discussed below), which is also transmitted to the network 108. The server 104 receives the media file and the kernel from the network 108 and stores the media file and first kernel in a repository. The server 104 allows access to the repository according to the first kernel. The second mobile device 106, like the first mobile device 102, is also capable of creating a second kernel (discussed below), wherein upon transmitting such second kernel to the server 104, the latter transmits a notice to the second mobile device 106 according to the first and second kernel. Upon reception of such notice, the second device 106 receives the media file from the repository according to the second kernel. It should be clear to a skilled artisan that the present invention is not limited to mobile devices and that various other devices, such as personal computers can be used to achieve the same task. It should also be clear to a skilled artisan that the first mobile device 102 and the second mobile device 106 are interchangeable and further that each of the devices 102 and 106 can be replaced by a corresponding first and second server.

The system 100 enables subscribers such as the first mobile device 102 and the second mobile device 106 to exchange files, such as media files, according to an ad-hoc specification created by one or both subscribers. This ad-hoc specification, referred to as the kernel, may be a function of time, space, channel identity, mask, or any combination thereof.

For instance, the first mobile device 102 creates a media file which contains (1) text message, including hyperlinks, utilizing a keyboard of the mobile device 102, (2) image, which may be obtained using a camera onboard the mobile device 102, (3) audio, which may be obtained using a microphone onboard the mobile device 102, and (4) video, which may be obtained using a video recorder onboard the mobile device 102. The first mobile device 102 also creates a kernel, specifying a time period, for instance from November 1 thru November 7 of that year, and a geographic location, for instance the GPS (Global Positioning System) coordinates of a nightclub, obtained via the device's onboard GPS system, where the user of the first device 102 has visited before and recorded the media file associated with that location. Accordingly, any other subscriber, using a device such as the second mobile device 106, who arrives at the GPS location, hence the nightclub, during the time period November 1 thru November 7, will be notified by the server 104 that one or more media file can be accessed by the second mobile device 106. The second mobile device 106 may receive one or more media files according to the second kernel. For instance, the second mobile device 106 creates and transmits a kernel to the server 104 specifying that only media files from the LifeChannel (discussed below) of the first mobile device 102 would be accepted by said second mobile device 106. The server 104 compares the first and second kernels and transmits the media file, if any, that matches the criteria specified by the kernels. In this manner, the user of the first mobile device 102 and the user of the second mobile device 106 have created an ad-hoc specification for exchanging media files.

The system 100 depicted in FIG. 1 is a network environment according to one preferred embodiment of the present invention. The mobile device 102 is equipped with appropriate hardware (not shown but known to skilled artisans) capable of utilizing a network media channel such as the one disclosed herein. Among the hardware is a microprocessor having internal flash memory, internal clock which may be a crystal-type oscillator or other oscillator mechanism known to those practiced in the art, and a power supply which may be a discrete or integrated circuit configured to supply the microprocessor appropriate DC voltage. The microprocessor operates to control various functions of the mobile device 102 including control of peripheral units such as a camera, video recorder, voice recognition unit, GPS unit, text editor, and any other hardware that would be required to implement and utilize the network media channel discussed herein. It is contemplated that the processor may be a combination of individual discrete or separate integrated circuits packaged in a single housing or it may be fabricated in a single integrated circuit.

The mobile device 102 is further equipped with a camera, including an image digitizer, capable of recording still images and a video recorder, including an image digitizer, capable of recording moving images. The still and moving images are stored in the internal memory of the mobile device 102 via a user interface, such as a push button key 110 and 112 of the mobile device 102. The mobile device 102 is further equipped with a system, such as a GPS system, capable of recording a GPS location of the mobile device 102, or any other means, such as triangulation, that allows the position of the mobile device to be determined. The GPS location may be stored using a user interface, such as a push button key 114 of the mobile device 102. The mobile device 102 is further equipped with a text editor capable of recording text. A user interface, such as a keyboard 116 or a voice recognition unit, including a voice digitizer, capable of transcribing voice into text, is used to enter and store text in the mobile device 102. The mobile device 102 is further equipped with a voice recorder, including a voice digitizer, capable of recording voice. A user interface, such as a microphone 118, is used to receive voice and the digitized voice data from the voice digitizer is stored in the mobile device 102. The mobile device 102 is further equipped with a timer unit capable of generating a point in time or a time period according to a user interface 120 of the mobile device 102. As such, the mobile device 102 is capable of creating a media file and a first kernel. The mobile device 102 is further equipped with a network interface (not shown but known to skilled artisans) that is capable of communicating with the server 104 via the network 108. The mobile device 102 may communicate with the server 104 by wired or wireless connection. Alternatively, the mobile device 102 may be equipped with a user interface (not shown but known to skilled artisans), including a system, method, and article of manufacture, capable of creating, accessing, manipulating, and displaying media files and/or kernels, to make full use of the capabilities and functionalities of the network media channel disclosed herein.

The network 108, depicted in FIG. 1 provides the necessary connections between the mobile device 102, the server 104, and the mobile device 106. The network 108 can be a combination of wired and wireless networks including the Internet, LANs, WANs, MANs, GSM, PSCs, known to skilled artisans.

According to one preferred embodiment, the network 108 comprises a presence-based network including presence-based network applications, known to skilled artisans, where end users of devices such as the mobile devices 102 and 106, and network elements such as the server 104, to know the status, availability, location, and type of device used by other end users.

The concept of presence was initially associated with instant messaging service. It allowed an online end user, utilizing a device such as the mobile device 102, to recognize the presence of another online end user, utilizing a device such as the mobile device 106, to send or receive messages. Today, presence has expanded to include monitoring the registration and the busy or idle status of any type of end user device, including mobile phones, PDAs, VoIP clients, traditional POTS phones, push-to-talk clients, multimedia clients, and more. In addition, the concept of presence has been extended to include availability, which allows an end user, utilizing a device such as the mobile device 102, to explicitly share their availability to communicate with other end users. Typical availability states include out of office, in a meeting with a client, in a conference call, on vacation, away sick, etc. An end user can provide this or similar information, or it can be inferred from the end user's online calendar. Another dimension to presence is location, which refers to the geographical location of an end user's device, such as the mobile devices 102 and 106. Wireless networks can triangulate signal strength measurements to provide the location of wireless handsets and PDAs. More recently, the concept of location was extended to laptop based, instant messaging clients or IP softphones that might connect to wireline access networks at work, home or remote locations. By collecting and disseminating presence information (status of end user devices, availability of the individual and location), subscribers can select the most effective and appropriate means of communicating. Presence-based network protocol and architecture discussed herein is well known in the art. A further discussion of this technology is available over the Internet at the Lucent Technologies Website: http://www.lucent.com/livelink/090094038005df2c_White_paper.pdf.

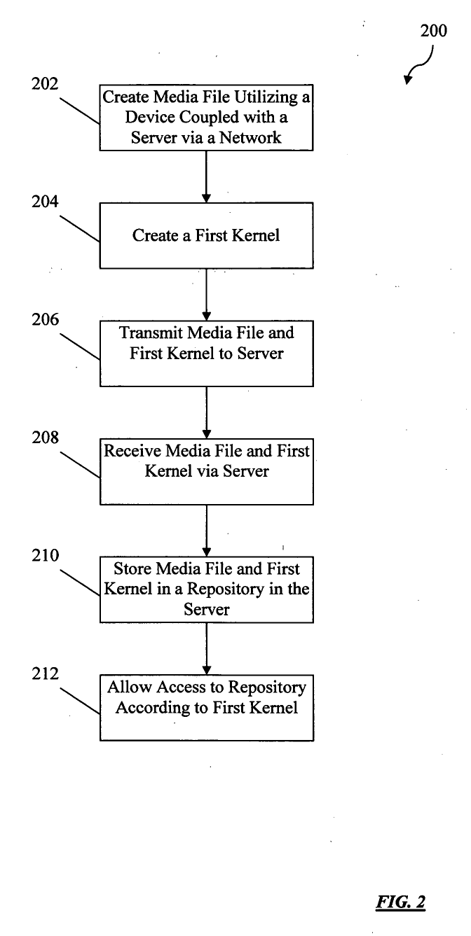

FIG. 2 shows a flow diagram 200 of one preferred method of providing a network media channel. This method may be implemented utilizing the mobile device 102, the network 108, and the server 104, shown in FIG. 1. According to this method, the mobile device 102 is used to create a media file at 202 and a first kernel at 204. The media file and kernel are transmitted to the network at 206, wherein the server 104 receives them, at 208, and stores the media file and first kernel in a repository in a local storage area of said server, at 210. The server 104 also provides access to the repository according to the first kernel at 212.

For instance, a user of the mobile device 102 creates a media file by entering text, audio, and video, using the user interfaces 110 thru 120, as discussed above, and stores it in the internal memory of the processor of the mobile device 102. The user also creates a first kernel which may contain a temporal component, a spatial component, a channel identity component, and a mask component. The user transmits both files to the server 104, where the server receives and stores the media file and first kernel in a repository. The server 104 uses one or more application modules from an application suite residing in the server to organize the repository. According to one example of the present embodiment, the server 104 associates the media file to the first kernel.

In one instance, a transmitting subscriber using the mobile device 102 creates a first kernel containing:
a. Temporal Component: the time period starting at 10:00 PM Dec. 2, 2005 and ending at 4:00 AM Dec. 3, 2005;
b. Spatial Component: GPS coordinate of CBGB in NY;
c. Channel Identity Component: LifeChannel; and
d. Mask Component: Mansour.
   The server 104 stores the media file and first kernel in a repository and transmits a notice to the network. One or more receiving subscribers who have a second kernel loaded into their devices comprising:
a. Temporal Component: any time between 10:00 PM Dec. 2, 2005 and 4:00 AM Dec. 3, 2005;
b. Spatial Component: GPS coordinate of CBGB in NY;
c. Channel Identity Component: LifeChannel; and
d. Mask Component: Mansour,
   will be notified and able to receive the media file from the repository. A variation of the present embodiment involves creating a first kernel that has multiple entries in each field. For example, a transmitting subscriber may enter two different temporal components for two different spatial components, such as a first temporal component as 10:00 PM Dec. 2, 2005 and 4:00 AM Dec. 3, 2005 for a first spatial component as GPS coordinate of CBGB in NY, and a second temporal component as 1:00 PM Dec. 11, 2005 and 4:00 PM Dec. 11, 2005 for a second spatial component as GPS coordinate of Soldier Field in Chicago. Such multiple entries allows a transmitting subscriber to direct a media file to subscribers in different locations and at different times.

In another instance, a transmitting subscriber using the mobile device 102 creates a first kernel containing:
a. Temporal Component: (blank);
b. Spatial Component: GPS coordinate of CBGB in NY;
c. Channel Identity Component: LifeChannel; and
d. Mask Component: Mansour.
   The server 104 stores the media file and first kernel in a repository and transmits a notice anytime a subscriber is present and whose second kernel matches the first kernel, i.e., containing a blank field for the temporal component, the GPS coordinates (CBGB in NY), the channel identity component (LifeChannel), and mask component (Mansour). Accordingly, one or more receiving subscribers who have a second kernel loaded into their devices comprising:
a. Temporal Component: (blank);
b. Spatial Component: GPS coordinate of CBGB in NY;
c. Channel Identity Component: LifeChannel; and
d. Mask Component: Mansour,
   will be notified and able to receive the media file from the repository.

The above examples illustrate that both the transmitting and receiving subscribers may control media file exchange. In a variation of the present embodiment, a server 104 maybe programmed to transmit a notice to a receiving subscriber when a field of either a first kernel or second kernel is left blank. Thus, according to this variation, when a field of a kernel is left blank, the constraint associated with that field of the kernel is ignored. In order to avoid network traffic congestion, the server may be programmed to reject a kernel with all fields set to blank, and to transmit a notice advising the subscriber to add one or more constraints to the kernel.

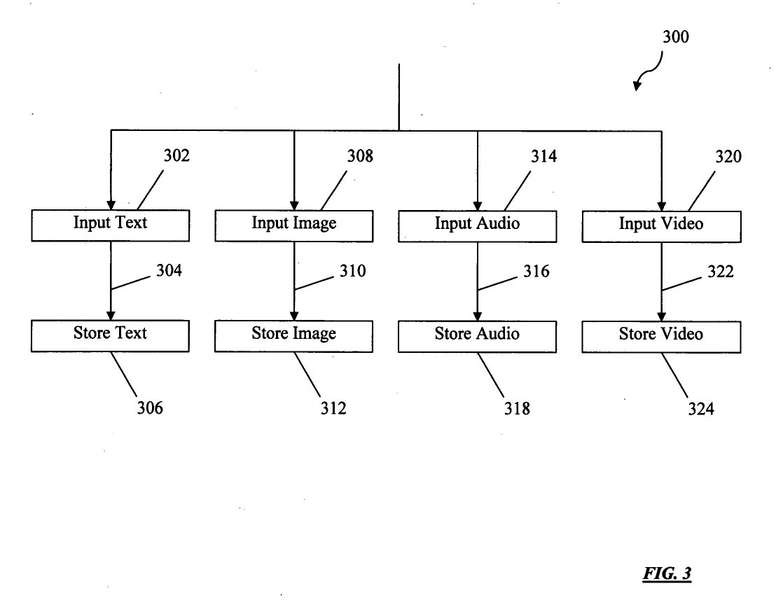

FIG. 3 shows a flow diagram 300 depicting one method of creating a media file using a device such as the mobile device 102. According to this method, a media file is created by inputting at least one of a text at 302, image at 308, audio at 314, and video at 320 and storing said text at 306, image at 312, audio at 318, and video at 324 in the media file, utilizing a memory of the processor embedded in the device. The text may be inputted at 302 using the device keyboard or voice transcriber unit. The image may be inputted at 308 using the camera onboard the device or otherwise coupled with the device. The audio may be inputted at 314 utilizing the device's onboard microphone and the video may be inputted at 320 using the device's onboard video recorder. Alternatively, a special-purpose user interface including appropriate hardware and software can be implemented to create the different components of the media file.

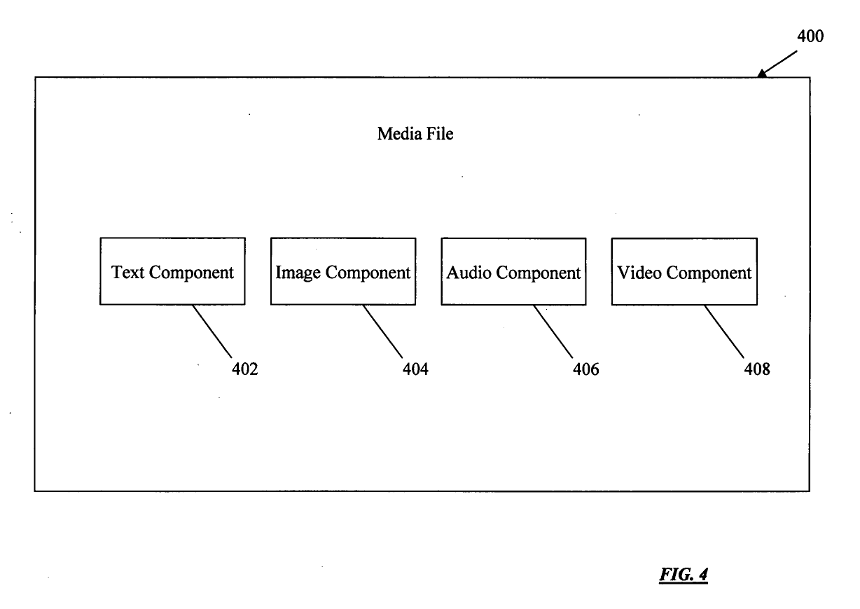

FIG. 4 shows one preferred embodiment of a media file 400 according to the present invention. According to this embodiment, the media file 400 comprises one or more components, namely a text component 402, an image component 404, an audio component 406, and a video component 408. According to one example of the present embodiment, the media file 400 contains digital data made up of four separate parts each part containing digital data associated with text, image, audio, and video, that a subscriber has created utilizing the device's keyboard, image, and voice digitizers, as discussed above. The text 402 may contain plain text, http, and/or html formatted text. The image 404 and/or video 408 may contain one or more digitized image obtained via the device's onboard camera and/or video recorder, or downloaded from another device such as the server 104. The audio component 406 may contain digitized audio acquired via the device's voice digitizer or it can be obtained from another device.

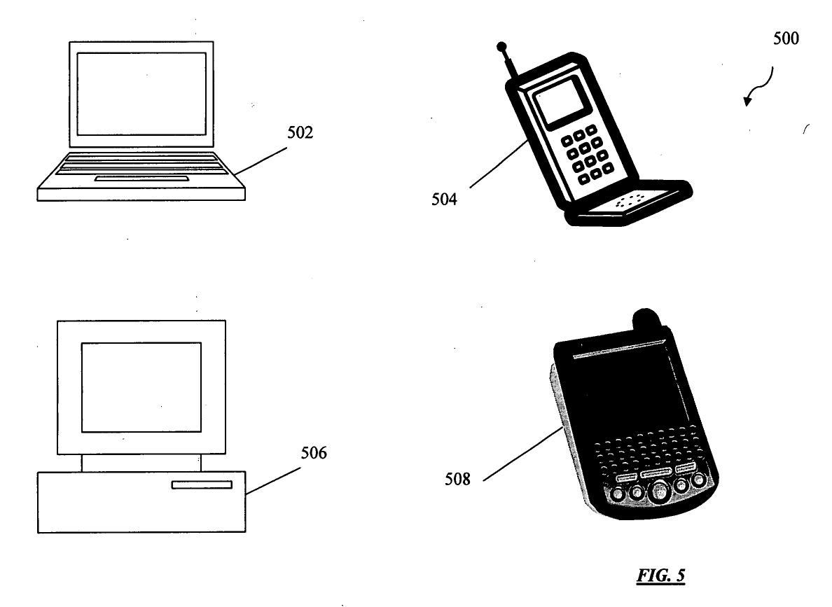

FIG. 5 shows various embodiments of a device 500 according to the present invention. A laptop 502, mobile phone 504, desktop 506, and PDA 508 may be used to communicate with the network 108 and send/receive media files as well as kernel files to/from the server 104. These or other devices, known to skilled artisans, may be coupled to the network 108 and server 104 via wired or wireless connection. For instance, the laptop 502 may be used to create a media file and a first kernel to be transmitted to the server 104 via the network 108. The laptop 502 is equipped with appropriate hardware and software to create and transmit the media file and first kernel to the server 104. One or more processors and interfaces, such as those discussed above, are used to achieve these tasks.

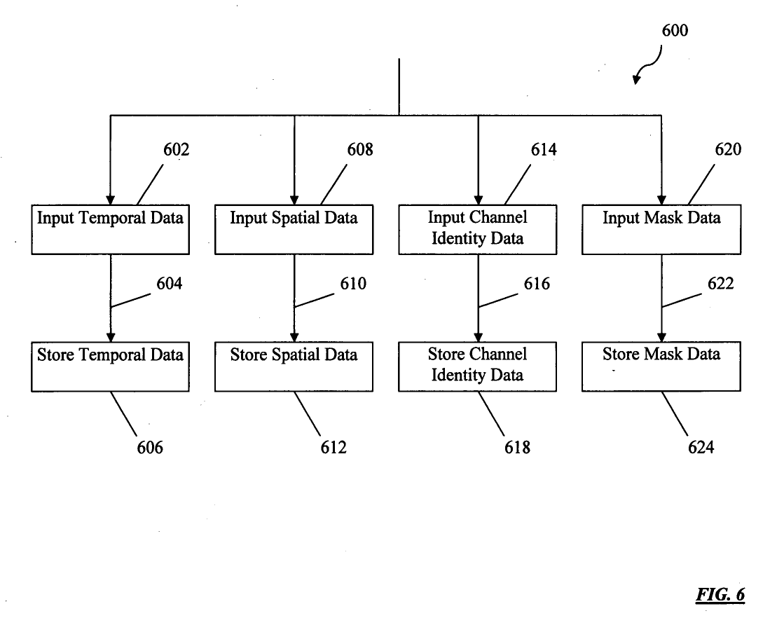

FIG. 6 shows a flow diagram 600 depicting one method of creating a kernel using a device such as the PDA 508. According to this method, a kernel is created by inputting at least one of a temporal data at 602, spatial data at 608, channel identity data at 614, and mask data at 620 and storing said temporal data at 606, spatial data at 612, channel identity data at 618, and mask data at 624 in the kernel, utilizing a memory of the processor embedded in the device. The temporal data may be inputted at 602 using the PDA's onboard timer unit, keyboard or voice transcriber unit of the PDA 508. The spatial data may be inputted at 608 using the PDA's embedded GPS system, triangulation system, keyboard, or voice transcriber unit. The channel identity data may be inputted at 614 utilizing the PDA's keyboard or voice transcriber unit. The mask data may be inputted at 620 using the PDA's keyboard or voice transcriber unit. Alternatively, a special-purpose user interface including appropriate hardware and software can be implemented to create the different components of the kernel.

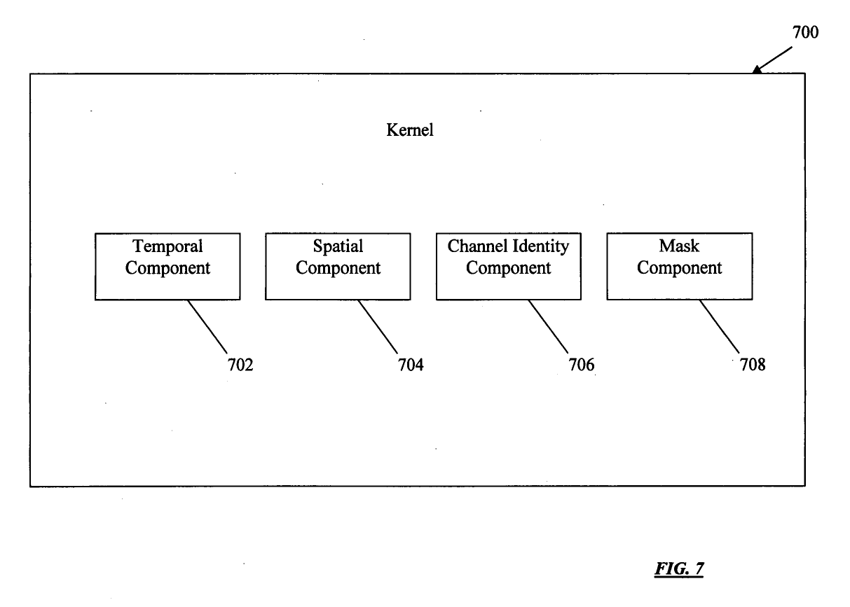

FIG. 7 shows one preferred embodiment of a kernel 700 according to the present invention. According to this embodiment, the kernel 700 comprises one or more components, namely a temporal component 702, a spatial component 704, a channel identity component 706, and a mask component 708. As mentioned above, each field of the kernel may comprise multiple entries for a particular media file. According to one example of the present embodiment, the kernel 700 is a data frame comprising one or more fields associated with the different components of the kernel. For instance the data frame may comprise four fields, each field having 128 bits containing digital data associated with the corresponding field. According to this example, the kernel 700 will be in the form of a data frame having 512 bits, wherein the first 128 bits are used to define the temporal component 702, 128 bits are used to define the spatial component 704, 128 bits are used to define the channel identity component 706, and 128 bits are used to define the mask component 708. The kernel 700 is transmitted along with the media file, such as that shown in FIG. 4, to be associated with the media file and notice, access, and retrieval of said media file will be according to the kernel 700. A repository (discussed in more detail below) will hold the media file of the subscribers along with the kernel 700.

A transmitting subscriber's first kernel, such as the kernel 700 determines the scope of access to the corresponding media file. A receiving subscriber's second kernel determines the scope of reception of media files, if any. In this manner, a transmitting subscriber controls the network's access to his/her media files and a receiving subscriber controls reception of media files available on the network.

A presence-based network and associated protocols can be utilized to provide a presence-based network media channel. A presence-based network media channel enables the system including a transmitting subscriber to know the status, availability, location, and type of device used by one or more receiving subscribers. Accordingly, a transmitting subscriber can make a more informed decision in creating a first kernel. For example, a transmitting subscriber who knows that a receiving subscriber is present but does not have the proper device may decide not to include images in the media file. In another instance, a transmitting subscriber who knows the location of a receiving subscriber that is present but not in a favorable location, for example, in a meeting, may decide not to include the receiving subscriber in the first kernel. Alternatively, a server may be programmed to choose the most suitable device for transferring the media file.

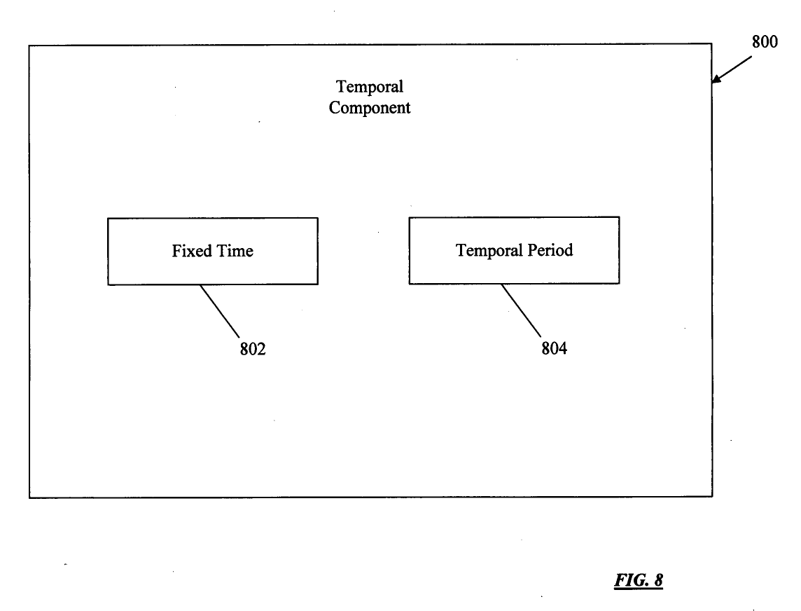

FIG. 8 shows one preferred embodiment of a temporal component 800 of a kernel such as that shown in FIG. 7. According to this embodiment, the temporal component 800 comprises a fixed time 802 and a temporal period 804. In one example, where the temporal component 800 contains only the fixed time 802, the server 104 allows access to the repository at any time after the fixed time 802. In another example, the temporal component 800 contains only the temporal period 804 and the server 104 allows access to the repository during the temporal period 802. In yet another example, where the temporal component 800 contains both the fixed time 802 and temporal period 804, the server 104 allows access to the repository at any time after the fixed time 802 and ending such access at the end of the temporal period 804. Any inconsistency as to the fixed time 802 and temporal period 804 may be resolved in favor of either the fixed time 802 or temporal period 804 which can be incorporated in the default setup conditions of the server 104. The server or device may be configured to apply real time by a respective onboard clock, as determined by the server or device, when considering the temporal component of a kernel.

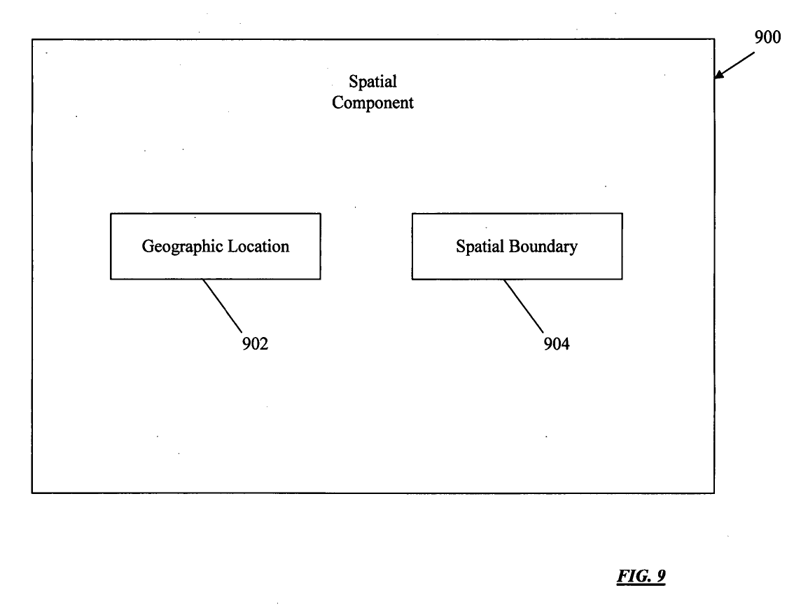

FIG. 9 shows one preferred embodiment of a spatial component 900 of a kernel such as that shown in FIG. 7. According to this embodiment, the spatial component 900 comprises a geographic location 902 and a spatial boundary 904. In one example, where the spatial component 900 contains only the geographic location 902, the server 104 allows access to one or more media files by one or more receiving subscribers who are transmitting a second kernel comprising the geographical location 902, assuming their second kernels meet the other constraints. In another example, the spatial component 900 contains only the spatial boundary 904 and the server 104 allows access to one or more media files by one or more receiving subscribers who are transmitting a second kernel comprising the spatial boundary 904, assuming their second kernels meet the other constraints. In yet another example, where the spatial component 900 contains both the geographical location 902 and spatial boundary 904, the server 104 may allow access to one or more media files by one or more receiving subscribers who are transmitting a second kernel comprising either the geographic location 902 or spatial boundary 904, assuming their second kernels meet the other constraints. The server or device may be configured to apply actual spatial coordinates by a respective onboard positioning system, as determined by the server or device, when considering the spatial component of a kernel.

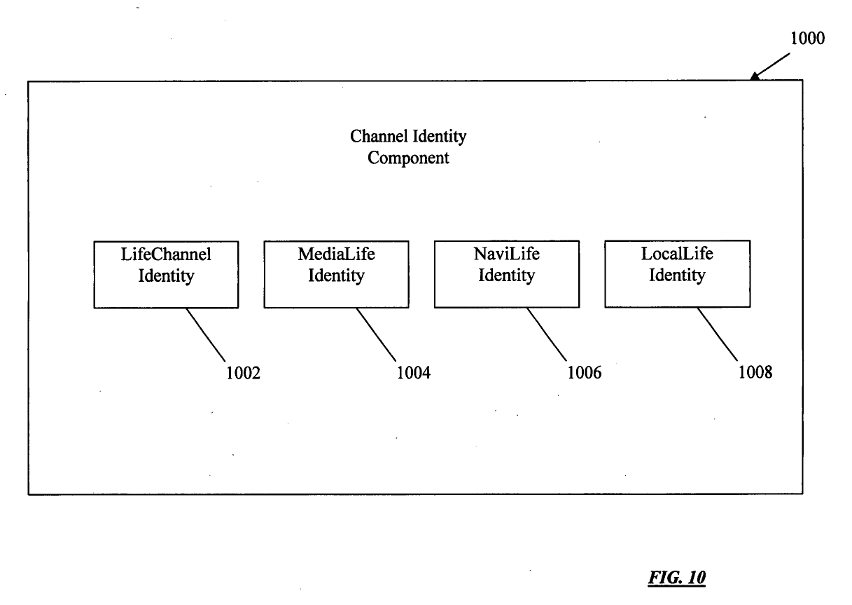

FIG. 10 shows one preferred embodiment of a channel identity component 1000 of a kernel such as that shown in FIG. 7. According to this embodiment, the channel identity component 1000 comprises a LifeChannel identity 1002, MediaLife identity 1004, NaviLife identity 1006, and LocalLife identity 1008. The channel identity component 1000 can be used to identify one or more category of artwork to which a media file should be associated. A subscriber may select one or more of the LifeChannel identity 1002, MediaLife identity 1004, NaviLife identity 1006, and LocalLife identity 1008 to associate a media file. For instance, a subscriber may choose to associate user-generated content with LifeChannel; entertainment and information content with MediaLife; scheduling and event content with NaviLife; and location content with LocalLife. According to one example, a channel identity component field of a kernel comprises two bits which may be used to choose any of the four categories to which a media file will be associated. A notice comprising the channel identity component 1000 notifies a receiving subscriber of the type of media file that has been created by a transmitting subscriber. A receiving subscriber may create a second kernel comprising a channel identity that selects one or more of the LifeChannel identity 1002, MediaLife identity 1004, NaviLife identity 1006, and LocalLife identity 1008. Accordingly, a receiving subscriber may utilize this field of the second kernel to tune into a particular content that a transmitting subscriber creates.

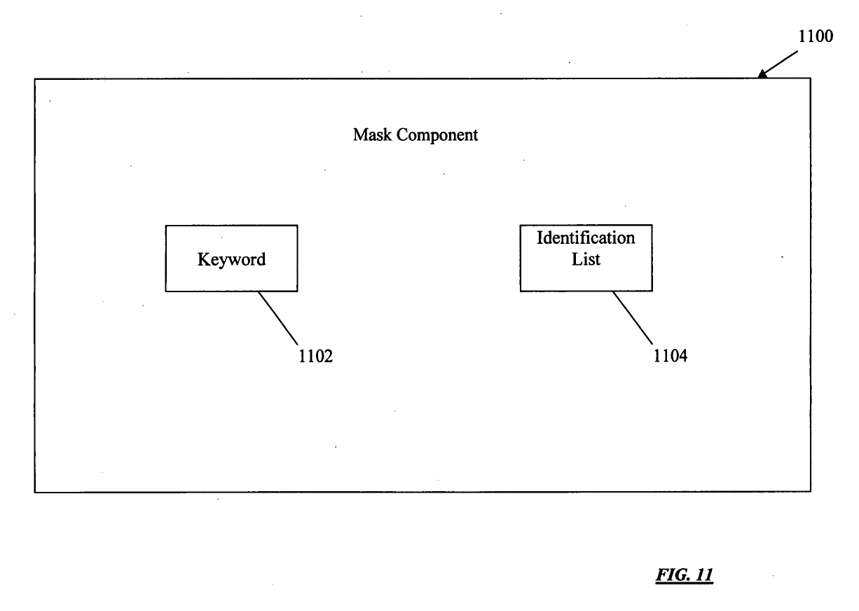

FIG. 11 shows one preferred embodiment of a mask component 1100 of a kernel such as that shown in FIG. 7. According to this embodiment, the mask component 1100 comprises a keyword 1102 and an identification list 1104. The keyword 1102 may be an expression, a date, or any other descriptive word that a transmitting subscriber may choose to use to associate a media file with. A receiving subscriber may, in turn, create a second kernel whose mask component contains a keyword that matches that of the first kernel. In this manner, a receiving subscriber can receive media files that are associated with a particular keyword.

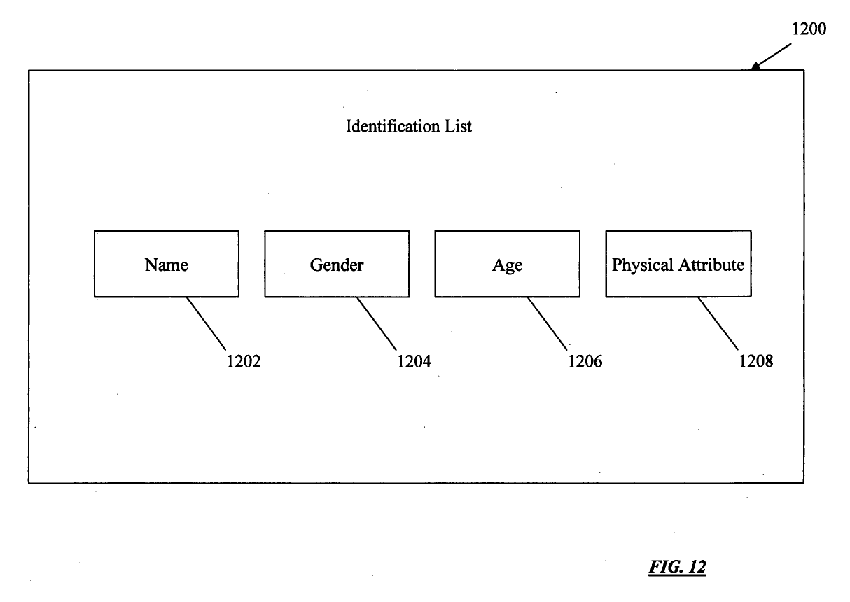

FIG. 12 shows one preferred embodiment of an identification list 1200. According to this embodiment, the identification list 1200 comprises at least one of a name 1202, gender 1204, age 1206, and physical attribute 1208. A transmitting subscriber may use the identification list 1200 to associate a media file with the name, gender, age, and/or physical attribute. Accordingly, when the server 104 transmits a notice with a mask component comprising the identification list 1200, only receiving subscribers matching the identification list 1200 with their second kernel will be able to receive the media file. In this manner, a transmitting subscriber may direct a media file to receiving subscribers that are of at least one of a specific name, gender, age, and physical attribute.

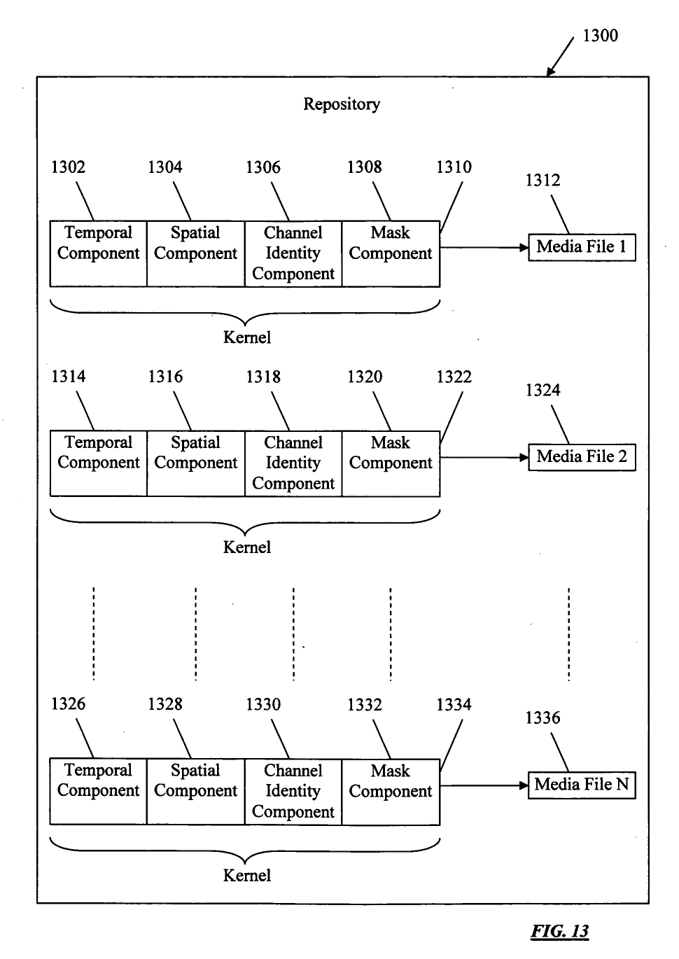

FIG. 13 shows one preferred embodiment of a repository 1300. Each subscriber to the network media channel is allocated a finite storage area, in the server 104, to store one or more media files in the repository 1300. According to this embodiment, the repository 1300 comprises one or more media files, each associated with a kernel. As discussed above, each kernel comprises at least one of a temporal component, spatial component, channel identity component, and mask component, and further that each field may contain multiple entries. A transmitting subscriber may have media files 1 thru N stored in the repository 1300, each associated with a kernel that may or may not be the same. For instance, media file 1 at 1312 may be associated with a kernel 1310 comprising a temporal component 1302, a spatial component 1304, a channel identity component 1306, and a mask component 1310. Media file 2 at 1324 may be associated with a kernel 1322 with a temporal component 1314, spatial component 1316, channel identity component 1318, and mask component 1322. Media file N at 1336 may be associated with a kernel 1334 which includes a temporal component 1326, spatial component 1328, channel identity component 1330, and mask component 1332. In one instance, two or more kernels may be identical but associated with two or more media files. In this scenario all media files that are associated with a first kernel that match a second kernel are accessible and can be downloaded by a receiving subscriber.

A notice is transmitted to all present subscribers via the server 104 according to a first and second kernel. In one instance, all subscribers having a second kernel that match a first kernel will be notified via their devices, for example an LED (light emitting diode) generating a flashing light pattern, a speaker generating a sound pattern, or a display showing a message.

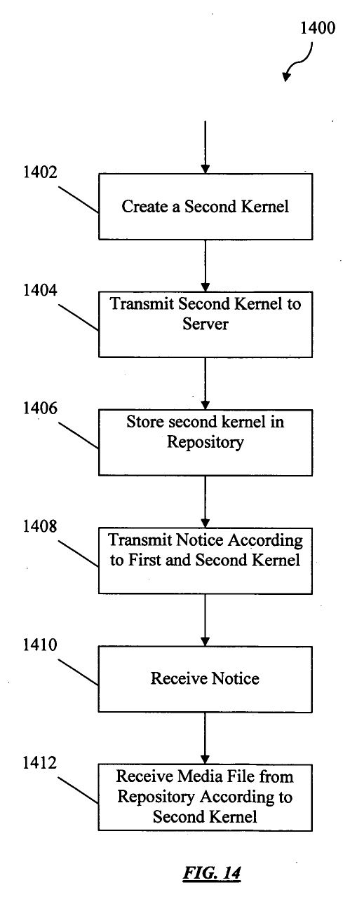

FIG. 14 shows a flow diagram 1400 of one preferred method of providing a network media channel. According to this method, a network media channel is provided by further creating a second kernel at 1402, transmitting the second kernel at 1404, storing the second kernel in a repository at 1406, transmitting a notice according to the first and second kernels at 1408, receiving the notice at 1410, and receiving the media file from the repository according to the second kernel at 1412. This method may be implemented utilizing the mobile device 106, the network 108, and the server 104, shown in FIG. 1. According to this method, a receiving subscriber using the mobile device 106 creates a second kernel as shown in FIG. 7. This second kernel determines the scope of a notice and the media file that is received by the receiving subscriber. The media file may be received by the mobile device 106 automatically or manually.

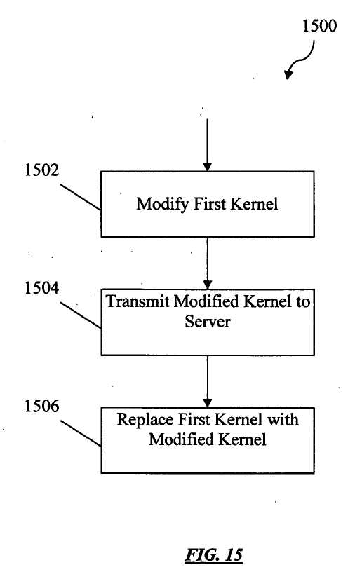

FIG. 15 shows a flow diagram 1500 of one preferred method of modifying a first kernel. According to this method, a transmitting subscriber may modify a first kernel at 1502 that may be associated with one or more media files. The modified first kernel is transmitted to the server 104 at 1504. The sever 104 is configured to replace the first kernel with said modified kernel at 1506. In this manner, one or more constraints of a kernel, hence, temporal, spatial, channel identity, and/or mask component may be modified at a later time by a transmitting subscriber. Accordingly, upon such modification, the server 104 may access the devices whose second kernel would be affected by such modification of the first kernel and modify, including deleting, one or more media files received by such receiving subscribers.

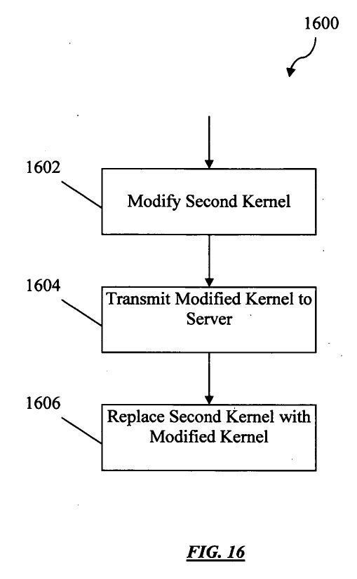

FIG. 16 shows a flow diagram 1600 of one preferred method of modifying a second kernel. According to this method, a receiving subscriber may modify a second kernel at 1602, transmit it to the server 104 at 1604, wherein the server 104 replaces the second kernel with said modified kernel at 1606. In this manner, a receiving subscriber may modify one or more fields of a second kernel at a subsequent time.

The forgoing discloses a network media channel that can be used to share media files among subscribers to the channel. The channel makes it possible for the subscribers to create their own ad-hoc filters according to their specifications. The channel allows a transmitting subscriber to create a media file and a first kernel to be stored in a server via a network. A receiving subscriber may create her own ad-hoc filter, hence second kernel, and further be notified by a server according to the first and second kernel, whereupon such notice, the receiving subscriber may have access to and may retrieve the media file. All references and distinctions with respect to transmitting and receiving subscribers, made herein, are for clarification purposes only. It should be clear to a skilled artisan that a transmitting subscriber may, at another instance, be a receiving subscriber and vice versa.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A method for providing a network media channel, comprising:
(a) creating a media file utilizing a device, said device coupled with a server via a network;
(b) creating a first kernel;
(c) transmitting said media file and first kernel to said network, via the device;
(d) receiving said media file and first kernel from said network, via the server;
(e) storing said media file and first kernel in a repository in said server; and
(f) allowing access to said repository across said network according to the first kernel.

2. The method of claim 1, wherein creating a media file comprises:
(i) inputting at least one of a text component, an image component, an audio component, and a video component; and
(ii) storing at least one of the text component, the image component, the audio component, and the video component, in the media file.

3. The method of claim 1, wherein said media file comprises at least one of a text component, an image component, an audio component, and a video component.

4. The method of claim 1, wherein said device is a client.

5. The method of claim 4, wherein said client comprises at least one of a mobile phone, a personal digital assistant, a personal computer, and a laptop computer.

6. The method of claim 1, wherein said network comprises a presence-based network.

7. The method of claim 1, wherein creating a first kernel comprises:
(i) inputting at least one of a temporal data, a spatial data, a channel identity data, and a mask data; and
(ii) storing at least one of the temporal data, the spatial data, the channel identity data, and the mask data in the first kernel.

8. The method of claim 1, wherein said first kernel comprises at least one of a temporal component, a spatial component, a channel identity component, and a mask component.

9. The method of claim 8, wherein said temporal component comprises at least one of a local time and a temporal period.

10. The method of claim 8, wherein said spatial component comprises at least one of a geographic location and a spatial boundary.

11. The method of claim 8, wherein said channel identity component comprises at least one of a LifeChannel identity, a MediaLife identity, a NaviLife identity, and a LocalLife identity.

12. The method of claim 11, wherein said LifeChannel identity identifies a user-generated content.

13. The method of claim 11, wherein said MediaLife identity identifies an entertainment and information content.

14. The method of claim 11, wherein said NaviLife identity identifies a scheduling and event content.

15. The method of claim 11, wherein said LocalLife identity identifies a location content.

16. The method of claim 8, wherein said mask component comprises at least one of a keyword and an identification list.

17. The method of claim 16, wherein said identification list comprises at least one of a name, a gender, an age, and a physical attribute.

18. The method of claim 1, wherein the steps (c) and (d) occur via at least one of a wired and a wireless connection.

19. The method of claim 1, wherein said repository comprises at least one of a LifeChannel component, a MediaLife component, a NaviLife component, and a LocalLife component.

20. The method of claim 1, wherein said notice comprises at least one of a temporal component, a spatial component, a channel identity component, and a mask component.

21. The method of claim 1, wherein said access is allowed according to at least one of a temporal component, a spatial component, a channel identity component, and a mask component.

22. The method of claim 1, further comprising:
(a) modifying the first kernel;
(b) transmitting said modified kernel to said server; and
(c) replacing said first kernel with said modified kernel.

23. The method of claim 22, further comprising modifying a received media file according to said modified first kernel.

24. The method of claim 1, further comprising:
(a) creating a second kernel;
(b) transmitting said second kernel to said server;
(c) storing said second kernel in the repository in said server;
(d) transmitting a notice to said network according to the first and second kernel, via the server;
(e) receiving the notice; and
(f) receiving said media file from said repository in said server according to the second kernel.

25. The method of claim 24, wherein said second kernel comprises at least one of a temporal component, a spatial component, a channel identity component, and a mask component.

26. The method of claim 24, further comprising:
(a) modifying the second kernel;
(b) transmitting said modified kernel to said server; and
(c) replacing said second kernel with said modified kernel.

27. A computer program embodied on a computer readable medium for providing a network media channel, comprising:
(a) a code segment that creates a media file utilizing a device, said device coupled with a server via a network;
(b) a code segment that creates a first kernel;
(c) a code segment that transmits said media file and first kernel to said network, via the device;
(d) a code segment that receives said media file and first kernel from said network, via the server;
(e) a code segment that stores said media file and first kernel in a repository in said server; and
(f) a code segment that allows access to said repository across said network according to the first kernel.

28. The computer program of claim 27, wherein the code segment that creates a media file comprises:
(i) a code segment that inputs at least one of a text component, an image component, an audio component, and a video component; and
(ii) a code segment that stores at least one of the text component, the image component, the audio component, and the video component, in the media file.

29. The computer program of claim 27, wherein said media file comprises at least one of a text component, an image component, an audio component, and a video component.

30. The computer program of claim 27, wherein said device is a client.

31. The computer program of claim 30, wherein said client comprises at least one of a mobile phone, a personal digital assistant, a personal computer, and a laptop computer.

32. The computer program of claim 27, wherein said network comprises a presence-based network.

33. The computer program of claim 27, wherein the code segment that creates a first kernel comprises:
(i) a code segment that inputs at least one of a temporal data, a spatial data, a channel identity data, and a mask data; and
(ii) a code segment that stores at least one of the temporal data, the spatial data, the channel identity data, and the mask data in the first kernel.

34. The computer program of claim 27, wherein said first kernel comprises at least one of a temporal component, a spatial component, a channel identity component, and a mask component.

35. The computer program of claim 34, wherein said temporal component comprises at least one of a local time and a temporal period.

36. The computer program of claim 34, wherein said spatial component comprises at least one of a geographic location and a spatial boundary.

37. The computer program of claim 34, wherein said channel identity component comprises at least one of a LifeChannel identity, a MediaLife identity, a NaviLife identity, and a LocalLife identity.

38. The computer program of claim 37, wherein said LifeChannel identity identifies a user-generated content.

39. The computer program of claim 37, wherein said MediaLife identity identifies an entertainment and information content.

40. The computer program of claim 37, wherein said NaviLife identity identifies a scheduling and event content.

41. The computer program of claim 37, wherein said LocalLife identity identifies a location content.

42. The computer program of claim 34, wherein said mask component comprises at least one of a keyword and an identification list.

43. The computer program of claim 42, wherein said identification list comprises at least one of a name, a gender, an age, and a physical attribute.

44. The computer program of claim 27, wherein the steps (c) and (d) occur via at least one of a wired and a wireless connection.

45. The computer program of claim 27, wherein said repository comprises at least one of a LifeChannel component, a MediaLife component, a NaviLife component, and a LocalLife component.

46. The computer program of claim 27, wherein said notice comprises at least one of a temporal component, a spatial component, a channel identity component, and a mask component.

47. The computer program of claim 27, wherein said access is allowed according to at least one of a temporal component, a spatial component, a channel identity component, and a mask component.

48. The computer program of claim 27, further comprising:
(a) a code segment that modifies the first kernel;
(b) a code segment that transmits said modified kernel to said server; and
(c) a code segment that replaces said first kernel with said modified kernel.

49. The computer program of claim 48, further comprising a code segment that modifies said received media file according to said modified first kernel.

50. The computer program of claim 27, further comprising:
(a) a code segment that creates a second kernel;
(b) a code segment that transmits said second kernel to said server;
(c) a code segment that stores said second kernel in the repository in said server;
(d) a code segment that transmits a notice to said network according to the first and second kernel, via the server; and
(e) a code segment that receives the notice; and
(f) a code segment that receives said media file from said repository in said server according to the second kernel.

51. The computer program of claim 50, wherein said second kernel comprises at least one of a temporal component, a spatial component, a channel identity component, and a mask component.

52. The computer program of claim 50, further comprising:
(a) a code segment that modifies the second kernel;
(b) a code segment that transmits said modified kernel to said server; and
(c) a code segment that replaces said second kernel with said modified kernel.

53. A system for providing a network media channel, comprising:
(a) logic that creates a media file utilizing a device, said device coupled with a server via a network;
(b) logic that creates a first kernel;
(c) logic that transmits said media file and first kernel to said network, via the device;
(d) logic that receives said media file and first kernel from said network, via the server;
(e) logic that stores said media file and first kernel in a repository in said server; and
(f) logic that allows access to said repository across said network according to the first kernel.

54. The system of claim 53, wherein the logic that creates a media file comprises:
(i) logic that inputs at least one of a text component, an image component, an audio component, and a video component; and
(ii) logic that stores at least one of the text component, the image component, the audio component, and the video component, in the media file.

55. The system of claim 53, wherein said media file comprises at least one of a text component, an image component, an audio component, and a video component.

56. The system of claim 53, wherein said device is a client.

57. The system of claim 56, wherein said client comprises at least one of a mobile phone, a personal digital assistant, a personal computer, and a laptop computer.

58. The system of claim 53, wherein said network comprises a presence-based network.

59. The system of claim 53, wherein the logic that creates a first kernel comprises:
(i) logic that inputs at least one of a temporal data, a spatial data, a channel identity data, and a mask data; and
(ii) logic that stores at least one of the temporal data, the spatial data, the channel identity data, and the mask data in the first kernel.

60. The system of claim 53, wherein said first kernel comprises at least one of a temporal component, a spatial component, a channel identity component, and a mask component.

61. The system of claim 60, wherein said temporal component comprises at least one of a local time and a temporal period.

62. The system of claim 60, wherein said spatial component comprises at least one of a geographic location and a spatial boundary.

63. The system of claim 60, wherein said channel identity component comprises at least one of a LifeChannel identity, a MediaLife identity, a NaviLife identity, and a LocalLife identity.

64. The system of claim 63, wherein said LifeChannel identity identifies a user-generated content.

65. The system of claim 63, wherein said MediaLife identity identifies an entertainment and information content.

66. The system of claim 63, wherein said NaviLife identity identifies a scheduling and event content.

67. The system of claim 63, wherein said LocalLife identity identifies a location content.

68. The system of claim 60, wherein said mask component comprises at least one of a keyword and an identification list.

69. The system of claim 68, wherein said identification list comprises at least one of a name, a gender, an age, and a physical attribute.

70. The system of claim 53, wherein the steps (c) and (d) occur via at least one of a wired and a wireless connection.

71. The system of claim 53, wherein said repository comprises at least one of a LifeChannel component, a MediaLife component, a NaviLife component, and a LocalLife component.

72. The system of claim 53, wherein said notice comprises at least one of a temporal component, a spatial component, a channel identity component, and a mask component.

73. The system of claim 53, wherein said access is allowed according to at least one of a temporal component, a spatial component, a channel identity component, and a mask component.

74. The system of claim 53, further comprising:
(a) logic that modifies the first kernel;
(b) logic that transmits said modified kernel to said server; and
(c) logic that replaces said first kernel with said modified kernel.

75. The system of claim 74, further comprising modifying said received media file according to said modified first kernel.

76. The system of claim 53, further comprising:
(a) logic that creates a second kernel;
(b) logic that transmits said second kernel to said server;
(c) logic that stores said second kernel in the repository in said server;
(d) logic that transmits a notice to said network according to the first and second kernel;
(e) logic that receives the notice; and
(f) logic that receives said media file from said repository in said server according to the second kernel.

77. The system of claim 76, wherein said second kernel comprises at least one of a temporal component, a spatial component, a channel identity component, and a mask component.

78. The computer program of claim 76, further comprising:
(a) a code segment that modifies the second kernel;
(b) a code segment that transmits said modified kernel to said server; and
(c) a code segment that replaces said second kernel with said modified kernel.

79. A system for providing a network media channel, comprising:
(a) a first device capable of creating a media file and a first kernel and transmitting said media file and first kernel to a network;
(b) a server coupled with the device via the network and capable of receiving the media file and first kernel from the network, storing the media file in a repository according to the first kernel, and allowing access to the repository according to the first kernel
(c) a second device coupled with the server via the network and capable of creating a second kernel, transmitting said second kernel to said server, wherein the server stores said second kernel in the repository in said server and transmits a notice to the network according to the first and second kernel, receiving the notice, and receiving the media file from the repository in the server according to the second kernel.
